(19) United States
(12) Patent Application Publication
(10) Pub. No.: US 2003/0015371 A1
(43) Pub. Date: Jan. 23, 2003

(54) Stepladder safety device

(76) Inventor: William J. Coore, Siler City, NC (US)

Correspondence Address: OLIVE & OLIVE, P.A., 500 MEMORIAL STREET, PO BOX 2049, DURHAM, NC, 27702, US

(21) Appl. No.: 09/907,352

(22) Filed: Jul. 17, 2001

(51) Int. Cl. E06C 5/32

(52) U.S. Cl. 182/129

(57) ABSTRACT

The present invention relates to a stepladder safety device which fits on the upper portion of a conventional stepladder and is shaped to prevent or deter normal use of the top platform and top step of the stepladder.

### FIELD OF THE INVENTION

The present invention relates to a stepladder safety device. The invention particularly is directed to a safety device for a stepladder which prevents or deters the user of the stepladder from standing on the top step and top platform of the stepladder. The invention also is directed to stepladders having such safety device as an integral part of the stepladder.

### BACKGROUND OF THE INVENTION

Stepladders are widely used in situations where extension ladders, fixed ladders or other single sided ladders will not work or are impractical. Specifically, stepladders are a freestanding A-frame type construction with standard sizes running from about 2 feet to about 16 feet in height and taller. Stepladders tend to be more stable in use than extension ladders due to the base formed by the A-frame construction. Stepladders, however, have a safety drawback in that the top platform and top step of a stepladder are unstable positions and thus not suited for actually standing on, even though the construction and design of the top platform and top step are such that standing on them is possible. OSHA regulations have made it illegal to use the top platform and top step of stepladders in commercial construction situations. All stepladders sold in the United States for commercial or residential use must have a warning on the top step and top platform not to stand upon them. The top platform and top step of a stepladder are cross members positioned for the structural integrity of the stepladder but are normally shaped like steps and indistinguishable from the rest of the steps of a stepladder. These design choices, made by stepladder manufacturers, add to the problems associated with the safety of stepladders. In situations where a little extra height is needed by the user already on a stepladder, it is easy to ignore or just forget the rules, regulations and printed warnings for the stepladder and use what looks like a step, i.e. the top step or top platform, to gain extra height rather than obtain a larger stepladder. This scenario is especially true in commercial situations where workers are judged on the quantity of work they produce per unit of time and therefore safety is often disregarded in favor of ease or speed. Misuse of stepladders has become such a problem with construction workers that an OSHA representative frequently visits construction sites looking for violations of the safety rules relating to stepladders. Citations against construction companies are frequent, as are accidents caused by misuse of the top step and top platform of stepladders.

Guards for preventing or deterring people from climbing ladders are well known. However, such ladder guards have been limited to extension ladders and single sided non-extending ladders, e.g. on the sides of pools, buildings and the like. Essentially, the guards have been flat members covering a majority of the rungs on the ladder in a manner that the ladder cannot be used at all for its intended purpose. Such guards are designed to prevent unauthorized use of the ladder and need to be removed before any normal use of the ladder can be made. Normally, these types of safety devices are attached to the middle portion of the ladder and do not prevent use of the uppermost rung or step of the ladder. They simply prevent one from getting to them. None of the known guards are specifically directed for use on a stepladder. Further, none of the known guards are designed to be in use at the same time the stepladder is being used.

It would therefore be useful and the present invention has as its primary object to provide a safety device for a stepladder or provide a stepladder having a safety device as an integral part of the stepladder, to prevent use of the top step and top platform of the stepladder while still allowing normal use of the stepladder. Other objects will become apparent as the description proceeds.

### SUMMARY OF THE INVENTION

In fulfillment of the objects of the invention, a detachable stepladder safety device is provided according to one form of the invention. Also provided, according to another embodiment of the invention, is a stepladder having a safety device made as an integral part of the stepladder. In both embodiments, the safety device prevents use of the top step and top platform of the stepladder.

Specifically, the present invention, according to the first form referred to above, provides a safety device adapted to fit over the top platform and upper portions of an erect stepladder and comprises: a cap portion formed by an outwardly extending front wall and back wall, and a substantially closed top adapted, when the safety device is installed on the erect stepladder, to position the cap portion immediately above the top platform and position the front and back walls to surround the top platform and selected upper portions of the stepladder. The safety device is shaped in a manner designed to deter and prevent normal use of the top platform and of the top step of the stepladder.

The cap portion can have a variety of shapes to achieve the goal of the invention. It is the essence of the invention that the shape of the cap portion is such that it prevents or deters normal level standing i.e. normal use of the top platform. The front and back wall essentially come together to form a substantially closed top. So, for example, the cap portion can be shaped to form a peak, a ridge or any shape which makes normal use of the top platform difficult or impossible.

The front wall of the safety device extends downward from the cap portion such that it blocks or covers the top step of the stepladder in a manner that deters or prevents normal use of the top step of the stepladder. Various shapes may be used. For example, the front wall may be shaped as a flat sheet extending downward from the cap portion wide enough and long enough to extend past the top step.

While the safety device of the invention is primarily designed to be added to an existing conventional stepladder, it is also contemplated that the stepladder can be constructed with the safety device being an integral part of the stepladder.

Attaching the safety device of the invention to a stepladder can be achieved by any suitable means. So, for example, it can be attached using screws, clips, hook and loop fasteners, rivets, grommets or the like. In one form of the invention, the safety device cap portion has an open bottom so that the safety device press fits over the top platform of the stepladder. In another form, the safety device is screwed to the stepladder. The safety device of the invention, in still another form, provides a stepladder with such safety device as an integral part thereof.

The stepladder safety device, of the present invention lends itself to being formed of metal, plastic, wood, plastic impregnated fabric cloth or the like and may be of welded, molded, or other construction.

### BRIEF DESCRIPTION OF THE DRAWINGS

FIG. 1 is a fragmentary exploded perspective view of a first embodiment of the invention ready to be mounted on a stepladder, the stepladder being shown in dashed lines for purpose of illustration.

FIG. 2 is a fragmentary perspective view of the first embodiment of the invention of FIG. 1 mounted on a conventional stepladder.

FIG. 3 is a perspective view of the first embodiment of the invention of FIG. 1 illustrating its open bottom.

FIG. 4 is a perspective view of a second embodiment of the invention.

FIG. 5 is a perspective view of a third embodiment of the invention.

FIG. 6 is a fragmentary perspective view of a fourth embodiment of the invention in which the stepladder safety device of the invention is formed to serve as an integral part of a stepladder.

### DETAILED DESCRIPTION OF THE PREFERRED EMBODIMENTS

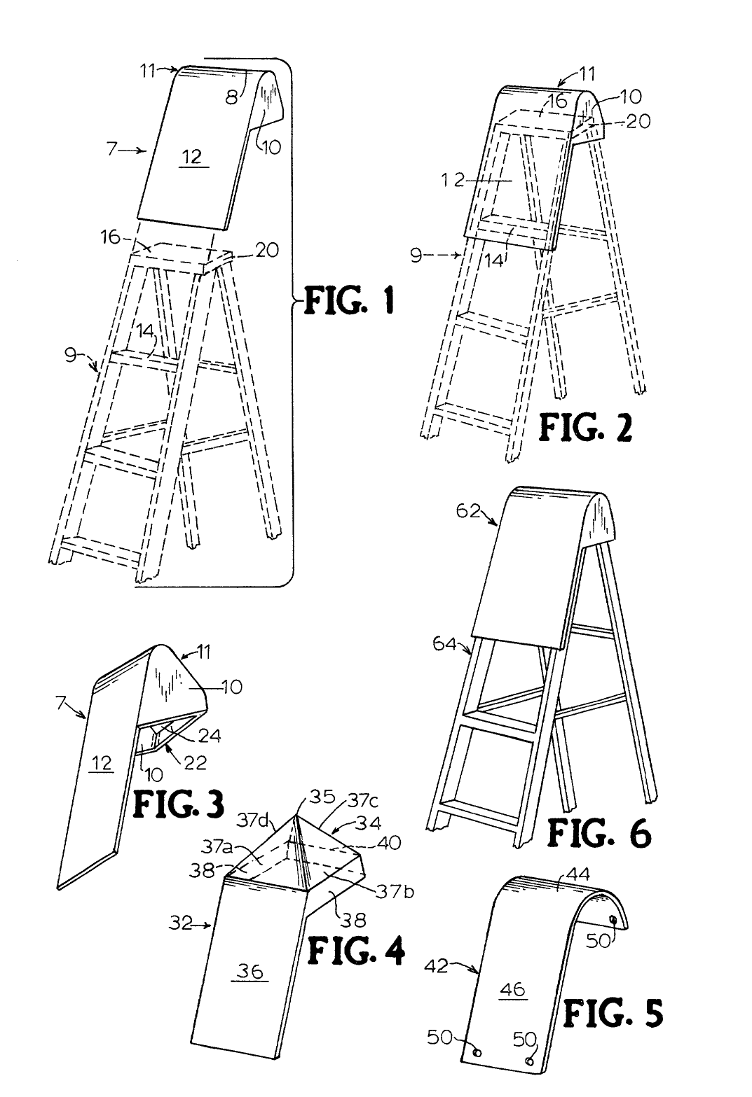

Referring now to the drawings in greater detail. FIG. 1 is a fragmentary, exploded perspective view of the first embodiment of the invention stepladder safety device 7 and a conventional stepladder 9 onto which it is placed. Cap portion 11 has a tapered ridge design that comes to a rounded edge 8 formed by a pair of opposing sides 10, a downwardly and outwardly inclined front wall 12 and a downwardly and outwardly inclined back wall 24 (FIG. 3). When safety device 7 is placed on stepladder 9, safety device 7 covers the stepladder top platform 16 and top step 14, deterring or preventing their normal use. FIG. 2 is a perspective view of safety device 7 showing cap portion 11 appropriately sized and affixed, by means of a press fit, over top platform 16 of stepladder 9. Front wall 12 of the safety device 7, once in place, covers top step 14 preventing normal use of both top step 14 and platform 16 of stepladder 9. Cap portion 11 has a pair of opposing sides 10 which fit correspondingly over the sides 20 of stepladder 9 and top platform 16.

FIG. 3 is a perspective view, looking upward into cap portion 11, of safety device 7. Front wall 12, side walls 10, and back wall 24 surround opening 22 under cap portion 11. In this first embodiment, opening 22 is sized to fit over top platform 16 of stepladder 9 for the purpose of installing it and retaining it on stepladder 9 by means of a press fit. Open bottom 22 is thus a useful feature since it can be sized to fit relatively snugly over top platform 16 and yet be easily removed. Nevertheless, it is recognized that cap 11 could be formed with a closed bottom (not shown) joined to the front, side and back walls and adapted to rest on platform 16.

FIG. 4 is a perspective view of a second embodiment of the invention, numbered stepladder safety device 32. In this embodiment, sloping walls 37a, 37b, 37c, 37d of cap portion 34 forms a point 35 rather than a tapered ridge as in the first embodiment. Stepladder safety device 32 also includes a front wall 36, a pair of opposing sidewalls 38, and a rear wall 40. Stepladder safety device 32 fits on the top platform of a stepladder in the same manner as stepladder safety device 7 of the first embodiment.

FIG. 5 is a fragmentary perspective view of a stepladder safety device 42 of the invention according to a third embodiment. In this third embodiment, stepladder safety device 42 has a curved cap portion 44 but no side walls as in the other embodiments. Stepladder safety device 42 has a front wall 46 which covers the top step of a conventional stepladder. In this third embodiment, stepladder safety device 42 can be mounted on and attached to a conventional stepladder using mounting holes 50 by use of screws, nails, or the like (not shown) that fit through mounting holes 50 and into the conventional stepladder. This is an especially effective attachment method for conventional stepladders made of wood.

FIG. 6 is a fragmentary perspective view of a stepladder safety device of the present invention according to a fourth embodiment. In this fourth embodiment, stepladder safety device 62 is formed and welded or molded, dependent on the material being used, as an integral part of stepladder 64 and covers an existing top platform. Stepladder safety device 62 thus replaces or makes unavailable for use the top platform and top step.

It is clear that there will be variations in the shape of the cap portion, and walls including the front wall, means of attachment, and the like within the scope of the invention. Those skilled in the art, to which this invention pertains, will clearly understand those variations and the claimed scope of the invention.

What is claimed is:

1. A stepladder safety device adapted to fit on the top platform and upper portions of a conventional erect stepladder comprising a cap portion formed by an outwardly extending front wall and back wall and a substantially closed top and being adapted when said safety device is installed on said erect stepladder to position said cap portion immediately above said top platform and with said front wall and back wall in position to surround and cover selected upper portions of said conventional erect stepladder including its top platform and top step, said substantially closed top being shaped in a manner designed to deter and prevent its use as a step.

2. A stepladder safety device as claimed in claim 1 wherein said substantially closed top is shaped to form a tapered ridge above said top platform.

3. A stepladder safety device as claimed in claim 1 wherein said substantially closed top is shaped to form a peak above said top platform.

4. A stepladder safety device according to claim 1 wherein said stepladder cap portion is also formed by sidewalls joined to said front and back walls.

5. A stepladder safety device according to claim 1 wherein said stepladder safety device is made of metal.

6. A stepladder safety device as claimed in claim 1 wherein said stepladder safety device is made as a molded structure.

7. A stepladder safety device as claimed in claim 1 wherein said stepladder safety device is made of wood.

8. A stepladder safety device as claimed in claim 1 wherein the stepladder safety device is formed as an integral part of said stepladder.

9. A stepladder safety device as claimed in claim 1 wherein said cap portion has an open bottom sized to permit a press fit of said cap portion when said stepladder safety device is installed on said stepladder.

10. A stepladder safety device as claimed in claim 4 wherein said cap portion has an open bottom sized to permit a press fit of said cap portion when installed on said stepladder.

11. A stepladder safety device for an erect stepladder adapted for preventing use as a step of either its top platform or top step comprising a cap having a downwardly extending and outwardly inclined front wall joined through a top surface of the cap to a downwardly extending and outwardly inclined back wall, said front and back walls providing coverage over both said top platform and top step when said cap is installed on said stepladder and said cap top surface joining said front and back walls being shaped so as to substantially prevent its use as a step.

12. A stepladder safety device as claimed in claim 11 wherein said cap also has side walls joined to said front and back walls and said cap is formed with an open bottom sized to permit a press fit of said cap when installed on said stepladder.

13. A stepladder safety device as claimed in claim 11 wherein said cap also has side walls joined to said front and back walls and said cap is formed with a closed bottom wall adapted to rest on said top step and support said safety device when installed on said stepladder.

14. A stepladder safety device as claimed in claim 1 wherein said safety device is formed as an integral part of the stepladder.
